(19) United States
(12) Patent Application Publication
(10) Pub. No.: US 2006/0176452 A1
(43) Pub. Date: Aug. 10, 2006

(54) Light tunnel and projection apparatus having same

(75) Inventors: Jin-sik Kim, Suwon-si (KR); Sung-tae Kim, Seoul (KR); Jeong-ho Nho, Suwon-si (KR); Kee-uk Jeon, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/347,432

(22) Filed: Feb. 6, 2006

(30) Foreign Application Priority Data
Feb. 4, 2005 (KR) 2005-10764

(51) Int. Cl. G03B 21/28

(52) U.S. Cl. 353/98

(57) ABSTRACT

A light tunnel and a projection apparatus having the same provide an improved degree of optical separation and an improved image forming efficiency. The light tunnel standardizes the intensity distribution of light emitted from a light source. The light tunnel comprises an incident plane and an emitting plane for the light. In addition, the size of the emitting plane is larger than that of the incident plane, and the emitting plane is inclined at a certain angle (θ) relative to the incident plane. With this configuration, the degree of optical separation and image forming efficiency of an illumination light is improved. The improved degree of optical separation also improves the contrast ratio, while allowing a compact optical system.

### CROSS-REFERENCE TO RELATED APPLICATIONS

This application claims the benefit under 35 U.S.C. § 119(a) of Korean Patent Application No. 2005-10764, filed Feb. 4, 2005, the entire contents of which are hereby incorporated by reference.

### BACKGROUND OF THE INVENTION

1. Field of the Invention

The present invention relates to a light tunnel and a projection apparatus having the same. More particularly, the present invention relates to a light tunnel and a projection apparatus that improves the degree of optical separation and the image formation efficiency of an illumination light by using a light tunnel that incorporates features of both wedge and taper type light tunnels.

2. Description of the Related Art

In general, a projection apparatus is a display apparatus that enlarges and projects an optical image formed by an image display device onto a projection surface, such as a screen. That is, the projection apparatus receives signals from various image devices such as a television (TV), a video cassette recorder (VCR), a digital versatile disk (DVD) player, a personal computer (PC) or a camcorder, and projects an optical image enlarged by a lens onto a screen.

The projection apparatus can be categorized as a first-generation CRT (Cathode Ray Tube) type, a second-generation LCD (Liquid Crystal Display) type, or a third-generation DMD (Digital Micro-mirror Device) type device according to the image display device used by the projection apparatus.

An LCD type projection apparatus has some drawbacks, such as a complex manufacturing process and low luminous intensity. Thus, DMD type projection apparatuses have been used recently due to their ability to form high-resolution images in a fully-digital manner. The DMD used in a DLP (Digital Light Processing) system is a semiconductor light switch that rotates a plurality of micro-mirrors on a DMD panel and reflects a transmitted light either onto (ON) or away from (OFF) a projection system to form an optical image.

Conventionally, the projection apparatus includes a light tunnel to convert a point light source generated by a lamp into a surface light source. The light tunnel is also referred to as a light integrator, a light pipe, or a glass rod.

The light emitted from the light tunnel is amplified in accordance with the size of the DMD by passing it through an illumination lens. A plurality of micro-mirrors are rotatably mounted in the DMD so that they can be rotated with respect to a certain axis of the DMD and its parallel axis. A controller controls the rotation of each micro-mirror in accordance with image data. In this way, each micro-mirror reflects incident light from the light source either onto the projection system (ON) or away from (OFF) the projection system.

The light reflected by a micro-mirror in the ON state is directed onto the projection system, while the light reflected by a micro-mirror in the OFF state is directed away from the projection system. Therefore, a pixel corresponding to a micro-mirror in the OFF state is seen as black, while a pixel corresponding to a micro-mirror in the ON state is seen as red, green, blue or a mixed color. An optical image is formed by a combination of the light reflected by each micro-mirror mounted in a DMD. The projection system compensates for any chromatic aberrations in the optical image, enlarges the optical image, and projects the optical image onto a screen.

FIG. 1A is a perspective view of a conventional rectangular-type light tunnel. The light tunnel 110, shown in FIG. 1A, has an appearance similar to a matchbox, and is formed from four rectangular mirrors. The mirrors are affixed in such a way that light is reflected inside the light tunnel. This type of rectangular light tunnel is the most commonly used light tunnel. As illustrated in FIG. 1A, the shape of an incident plane 10a is the same rectangular shape as that of an emitting plane 110b, and the planes 110a and 110b are parallel to each other.

FIG. 1B is a perspective view of a conventional wedge-type light tunnel. As shown in FIG. 1B, the wedge-type light tunnel 120 is formed from two rectangular mirrors and two trapezoidal mirrors, and the incident plane 120a and the emitting plane 120b are not parallel to each other. Instead, the emitting plane 120b is inclined at a certain angle (θ) with respect to the incident plane 120a.

FIG. 1C is a perspective view of a conventional taper-type light tunnel. In the taper-type light tunnel 130, the incident plane 130a and the emitting plane 130b are parallel to each other, but their sizes are different. For example, when the incident plane is 4″×4″, the emitting plane may be 6″×4″.

FIG. 2A is a schematic drawing for explaining an illumination system having a rectangular-type light tunnel 110. In the illustrated system, the reflector is an elliptical reflector. Accordingly, light coming from a closer focal point to the light source 210 is focused at a distant focal point. The light is directed into the light tunnel 110 as a point light source and is emitted from the light tunnel 110 as a surface light source.

The emitted light is enlarged through an illumination lens 220 in accordance with the size of the DMD 230. Because the DMD reflects the light emitted from the light tunnel, it is inclined relative to the optical axis (CR). Therefore, as illustrated in FIG. 2A, the illuminative image-forming plane 240 is at an angle with respect to the plane of the DMD 230. As a result, the conventional rectangular-type light tunnel has poor image-forming efficiency.

FIG. 2B is a schematic drawing for explaining an illumination system having the wedge-type light tunnel 120. As shown in FIG. 2B, the wedge-type light tunnel 120 is inclined at a certain angle relative to the illumination lens 220, and therefore, the image plane 240 is also inclined at a certain angle relative to the illumination lens. Thus, the wedge-type light tunnel 120 is used to overcome the drawback of the rectangular-type light tunnel 110, and image-forming efficiency is improved because the illuminative image-forming plane 240 is aligned with the plane of the DMD 230.

FIG. 2C is a schematic drawing for explaining an illumination system having the taper-type light tunnel 130. When the taper-type light tunnel is used, as illustrated in FIG. 2C, the incident angle on the reflective plane inside the light tunnel becomes large, and the reflective angle also becomes large. Therefore, the light emitted from the light tunnel has a narrow angular distribution of light and an improved degree of optical separation, which leads to a compact and slim illumination system.

Details on the degree of optical separation will now be described with reference to FIGS. 3A and 3B, which illustrate the degree of optical separation of the light tunnel shown in FIG. 2C. FIGS. 3A and 3B illustrate a process where incident light (IR) from the illumination system (not illustrated) is reflected by the DMD 230 and the emitted light (OR) is incident onto the projection system 310.

As shown in FIG. 3A, there is an area indicated by shading where incident light (IR) and the emitted light (OR) overlap. This overlap causes image quality to degrade because of interference between the incident light (IR) and the emitted light (OR). In the overlapped region of light, the farthest point from the DMD 230 is called an optical separation point (P). The shorter the distance (H) is between the optical separation point (P) and the DMD, the higher the degree of optical separation. The higher the degree of optical separation is, the higher the contrast ratio. Because the above distance (H) is the shortest distance from the DMD 230 necessary for installing the projection system 310, if the distance (H) becomes shorter, the projection system can be installed near the DMD to make a compact optical system.

As shown in FIG. 3B, if the light has a wide angular distribution of light, the optical separation point (P′) is farther away from the DMD 230. In addition, the distance (H′) between the optical separation point (P′) and the DMD 230 also becomes longer so that the degree of optical separation is degraded. Therefore, a wide angular distribution of light degrades the contrast ratio and makes it difficult to make a compact optical system.

A wedge-type light tunnel can improve the image-forming efficiency of the illumination light, but it cannot improve the degree of optical separation of the optical system. In contrast, the taper-type light tunnel can improve the degree of optical separation, but it cannot improve the image forming efficiency.

Accordingly, there is a need for an improved light tunnel for a projection apparatus which provides both an improved degree of optical separation and an improved image forming efficiency.

### SUMMARY OF THE INVENTION

An aspect of the present invention is to address at least the above problems and/or disadvantages and to provide at least the advantages described below. Accordingly, an aspect of the present invention is to provide a light tunnel and a projection apparatus having the same. More specifically, an aspect of the present invention is to provide an improved light tunnel and a projection apparatus having the same that provides an improved degree of optical separation and an improved image-forming efficiency of an illumination light by using a light tunnel that simultaneously applies features of both wedge- and taper-type light tunnels.

In accordance with an exemplary embodiment of the present invention, a light tunnel for a projection apparatus uniformly standardizes the intensity distribution of light provided by a light source. The light tunnel includes an incident plane and an emitting plane for the light, wherein the size of the emitting plane is larger than that of the incident plane, and the emitting plane is inclined at a certain angle (θ) relative to the incident plane.

The light tunnel may be formed by affixing the longer sides of four rectangular mirrors together. The incident and emitting planes of the light tunnel may be rectangular, and the light path from the incident plane to the emitting plane may be a hollow space.

The light tunnel may be formed from a hexahedral glass rod, and the incident and emitting planes may be rectangular. In addition, the light path from the incident plane to the emitting plane may be solid glass.

In accordance with another exemplary embodiment of the present invention, a projection apparatus comprises a light source that has a lamp and a reflective mirror for providing light, a light tunnel for converting the emitted point light into a surface light, and an illumination system for reflecting and emitting the surface light by means of the reflective mirror. In addition, the projection apparatus according to an exemplary embodiment of the present invention has an incident and an emitting plane for the light, wherein the size of the emitting plane is larger than that of the incident plane, and the emitting plane is inclined at a certain angle (θ) relative to the incident plane.

The light tunnel may be formed by affixing the longer sides of four rectangular mirrors together. The incident and emitting planes of the light tunnel may be rectangular, and the light path from the incident plane to the emitting plane may be a hollow space.

The light tunnel may be formed from a hexahedral glass rod, and the incident and emitting planes may be rectangular. In addition, the light path from the incident plane to the emitting plane may be solid glass.

The lamp may be an arc lamp or a halogen lamp.

The reflective mirror may be an elliptical or parabolic reflective mirror.

The projection apparatus according to an exemplary embodiment of the invention converts the light emitted from the illumination system into an optical image and includes a plurality of micro-mirrors rotatably installed on a substrate. The projection apparatus further includes a DMD (Digital Micro-mirror Device) for controlling the micro-mirrors and a projection system for enlarging and projecting the optical image formed by the DMD.

The projection apparatus may further include a screen onto which the optical image enlarged by the illumination system is projected.

Instead of a DMD, the projection apparatus may include an LCD (Liquid Crystal Display) or an LCOS (Liquid Crystal on Silicon) for receiving the light emitted from the illumination system and converting it into the optical image.

The projection apparatus may also includes a projection system for enlarging and projecting the optical image formed by the LCD or the LCOS.

The projection apparatus may further include a screen onto which the optical image enlarged by the illumination system is projected.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1A is a perspective view of a conventional rectangular-type light tunnel;

FIG. 1B is a perspective view of a conventional wedge-type light tunnel;

FIG. 1C is a perspective view of a conventional taper-type light tunnel;

FIG. 2A is a schematic drawing that shows the operation of an illumination system having the light tunnel of FIG. 1A.

FIG. 2B is a schematic drawing that shows the operation of an illumination system having the light tunnel of FIG. 1B;

FIG. 2C is a schematic drawing that shows the operation of an illumination system having the light tunnel of FIG. 1C;

FIGS. 3A and 3B are schematic drawings that show the degree of optical separation of the system shown in FIG. 2C;

FIG. 4 is a sectional view of a projection apparatus according to an exemplary embodiment of the invention;

FIG. 5 is an exploded perspective view of the illumination system and the projection system of FIG. 4;

FIG. 6 is a perspective view of the light tunnel of the light tunnel of FIG. 5, which simultaneously uses both the wedge and taper-types designs;

FIG. 7 is a schematic diagram that shows the operation of the illumination system having the light tunnel of FIG. 6; and

FIGS. 8 and 9 show an incident light distribution of the light tunnel according to an exemplary embodiment of the invention and an emitted light distribution of the light tunnel of FIG. 8, respectively.

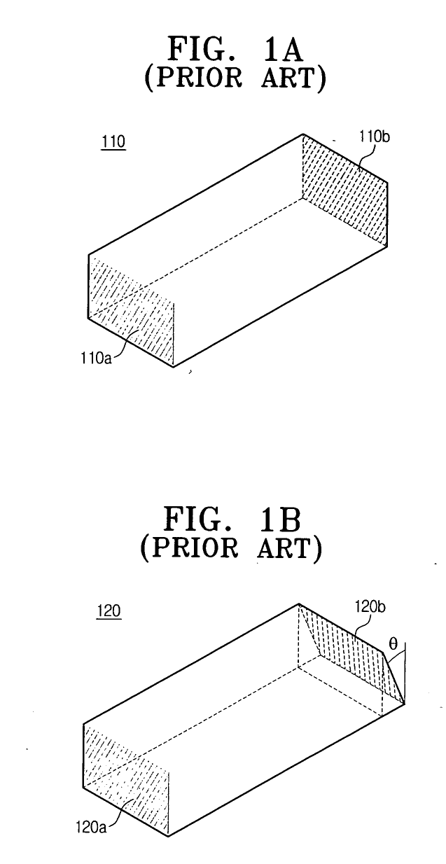

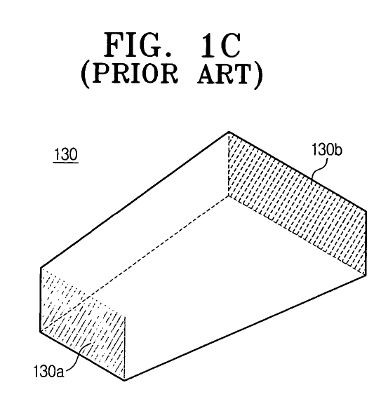

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

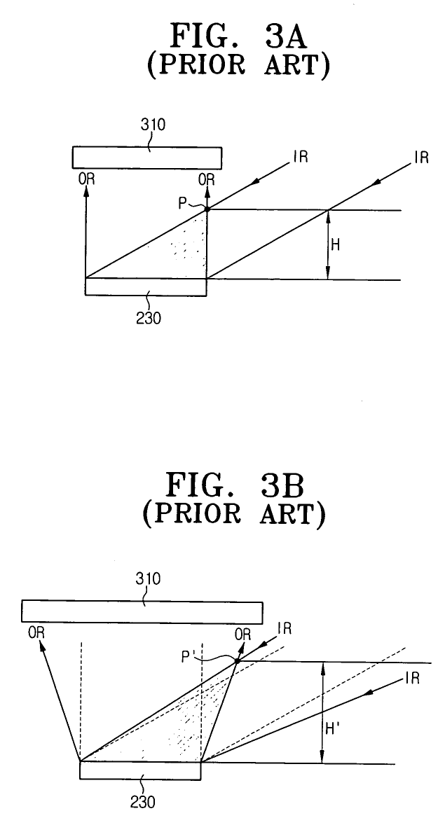

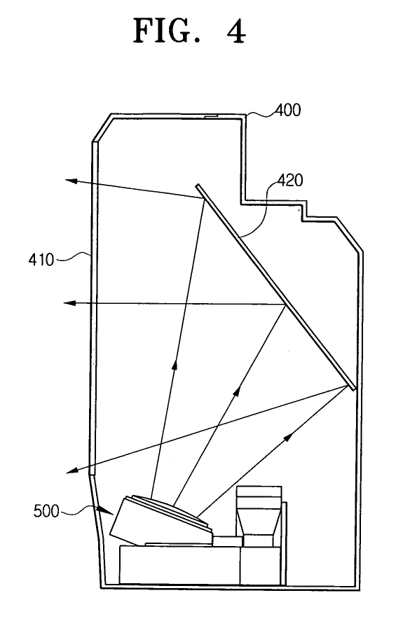

FIG. 4 is a sectional view of a projection apparatus according to one exemplary embodiment of the invention, and FIG. 5 is an exploded perspective view of the illumination system and the projection system of FIG. 4.

Referring to FIG. 4, the projection apparatus according to one exemplary embodiment of the invention comprises a main body 400 that forms the external appearance 10f the projection apparatus. A screen 410 is fixed on the main body 400, and a screen reflective mirror 420 enlarges and reflects an optical image onto the screen 410. An optical engine 500 forms and projects the optical image onto the screen reflective mirror 420. The optical engine 500 includes an illumination system and a projection system.

Referring to FIG. 5, the optical engine 500 comprises an illumination system 510, a DMD 550 and a projection system 560. The illumination system 510 is also called an illuminating optical system, and the projection system 560 is also called a projecting optical system.

The illumination system 510 includes a light source 520, a relay lens unit 530 and a reflective mirror unit 540.

The light source 520 includes a lamp 521 for generating light and an elliptical reflective mirror 522 for collecting the light generated by the lamp 521 and providing it to the relay lens unit 530.

According to another exemplary embodiment of the invention, a parabolic reflective mirror is used in place of the elliptical reflective mirror 522. In this case, the light generated at the focal point is emitted in parallel, and a lens for collecting the parallel light should be used prior to the relay lens unit 530. An arc lamp, a halogen lamp, an Ultra-High Performance (UHP) high intensity discharge lamp, or the like can be used as the lamp 521.

The relay lens unit 530 includes a color filter 531, a light tunnel 532 and a plurality of illumination lenses 533. The color filter 531 sequentially separates red, green and blue light from the light generated by the light source 520. The light tunnel 532 not only uniformly standardizes the density of the separated color light, but also forms the light into a rectangular shape. The multiple illumination lenses 533 collect the light passed through the light tunnel and provide it to the reflective mirror unit 540.

The reflective mirror unit 540 includes a first reflective mirror 541 and a second reflective mirror 542. The first reflective mirror 541 receives incident light passed through the multiple illumination lenses 533 and reflects incident light onto the second reflective mirror 542. In addition, the second reflective mirror 542 reflects the light reflected by the first reflective mirror 541 onto the DMD 550.

In the illustrated exemplary embodiment of the invention, two reflective mirrors 541 and 542 are used for projecting the light onto the DMD 550. One reflective mirror may be used, however, when the illumination system 510 is arranged at an appropriate position and angle.

The DMD 550 includes a substrate having a patterned electrical circuit, and a plurality of micro-mirrors rotatably installed on the substrate. The substrate has a rectangular shape having a major and a minor axis. The aspect ratio of the rectangular shape is preferably the same as that of the screen. In other words, the DMD 550 preferably has the same 16:9 or 4:3 aspect ratio as that of a conventional screen. In addition, the electrical circuit pattern on the substrate is electrically connected to a controller, which is not shown. The micro-mirrors independently rotate in accordance with a signal from the controller to thereby determine the reflection angle (ON or OFF) of incident light (IR), and irradiate a light of suitable color onto a pixel of the screen 410, shown in FIG. 4.

The micro-mirror, when rotated to a certain positive angle (+θ′), reflects incident light (IR) into the projection system 560 to thereby project it onto the screen 410 and form a pixel corresponding to the micro-mirror. That is, the when the micro-mirror is rotated to +θ′, the micro-mirror is ON. In contrast, when the micro-mirror is rotated to a certain negative angle (−θ′), the mirror reflects incident light (IR) away from the projection system 560, and the micro-mirror is OFF.

The projection system 560 is an apparatus for enlarging and projecting the optical image formed by the DMD 550, and includes at least one reflective mirror and a plurality of lenses for compensating for various aberrations in the optical image.

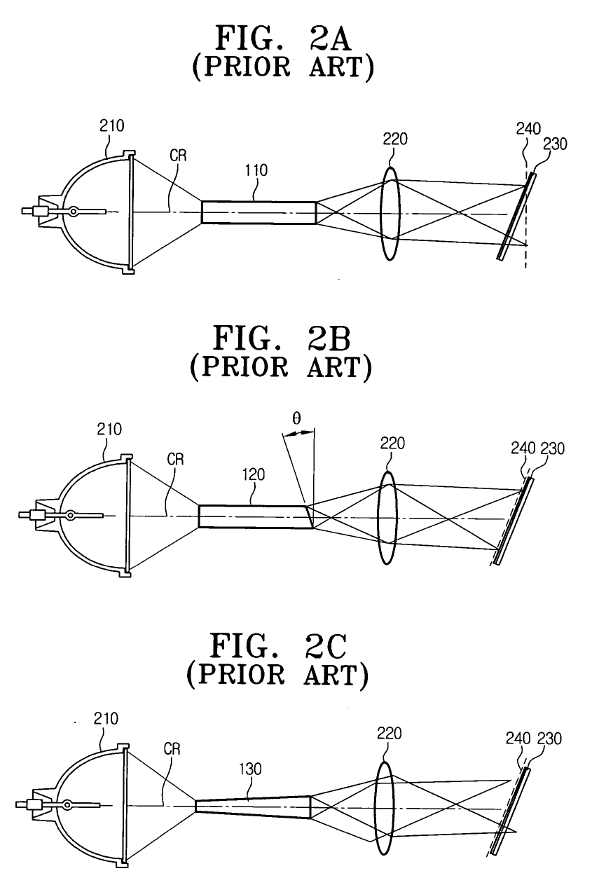

The aberrations become larger as the so-called BFL (Back Focal Length), the distance from the DMD 550 to a fixed point of the most rearward lens of the projection system 560 (like H shown in FIG. 3A) becomes greater. Therefore, when the distance (BFL) is greater, the number of lenses required for compensating for the aberrations increases. Moreover, designing the arrangement of the lens and the specifications for the lens becomes more difficult when the distance (BFL) is increased. Therefore, the quality of the image projected onto the screen 410 degrades as the distance (BFL) becomes greater. As such, the back focal length is an important factor in determining image quality and the size of the optical engine, and significant efforts are made in order to shorten its length.

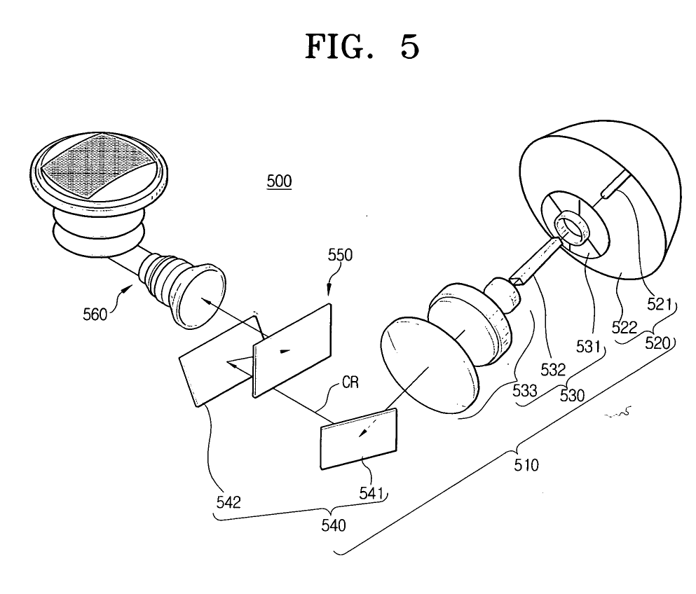

The light tunnel according to one exemplary embodiment of the invention will now be explained in detail, with reference to the drawings. FIG. 6 is a perspective view of s light tunnel that simultaneously applies features of both wedge and taper-type designs according to one exemplary embodiment of the invention.

The light tunnel according to one exemplary embodiment of the invention is formed in such a way that reflection occurs inside the light tunnel by forming the sides of the light tunnel from four mirrors. Specifically, the light tunnel is formed by affixing two rectangular mirrors and two trapezoidal mirrors so that the incident plane 532a and the emitting plane 532b are not parallel to each other and the emitting plane 532b is inclined at a certain angle (θ) (that is, a wedge-type design), and so that the incident plane and the emitting plane are parallel but with different sizes (that is, a taper-type design).

According to another exemplary embodiment of the invention, the light tunnel may be formed from a glass rod of both wedge and taper-types so that it has a structure filled with glass. Incident light is emitted after total reflection inside the glass rod.

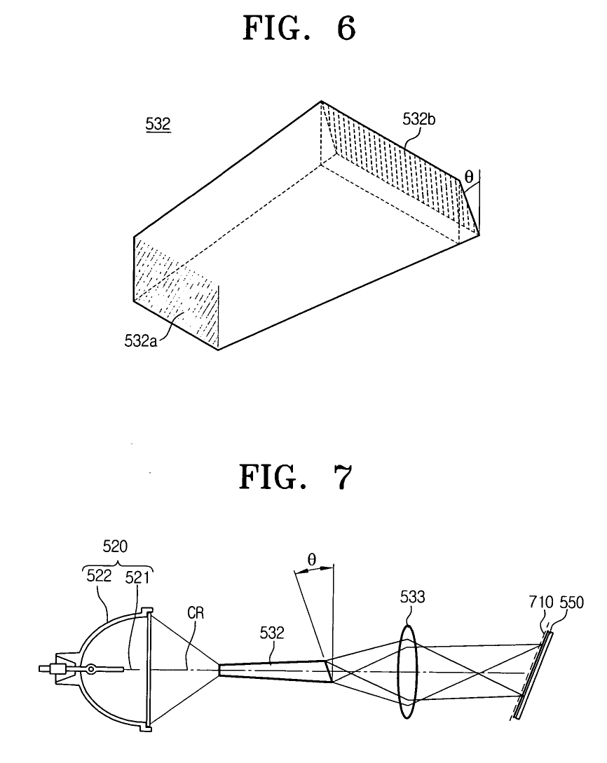

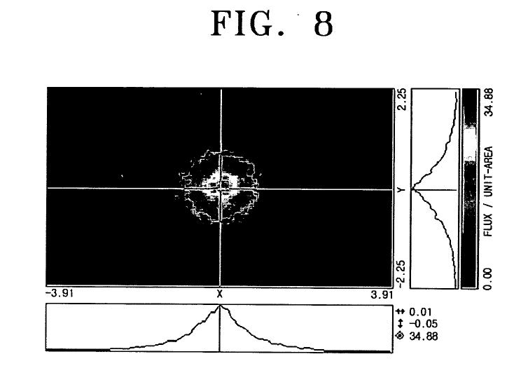

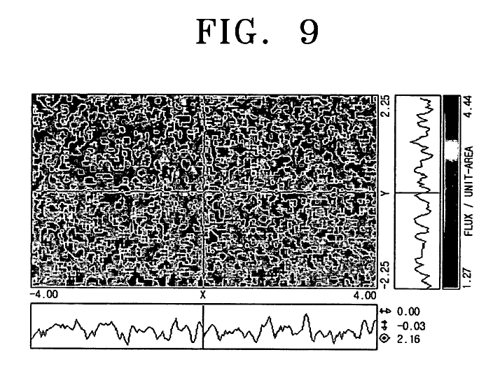

FIG. 7 is a schematic drawing for explaining the illumination system 510 including the light tunnel 532 of FIG. 6. FIG. 8 shows the incident light distribution of the light tunnel 532, and FIG. 9 shows the emitted light distribution of the light tunnel of FIG. 8.

Since the reflective mirror 522 of the light source 520 is elliptical, light emitted from the close focal point of the light source 520 is focused onto a distant focal point. Therefore, as illustrated in FIG. 8, the point light source is projected onto the light tunnel 532 and then, as illustrated in FIG. 9, is emitted as the surface light source. The emitted light is enlarged by the illumination lens 533 in accordance with the size of the DMD 550.

The DMD 550 is inclined relative to the optical axis (CR) for reflecting the light emitted from the light tunnel. Therefore, as illustrated in FIG. 7, when a wedge-type light tunnel inclined at a certain angle (θ) relative to the illumination lens 533 is used, image forming efficiency is improved because the illumination plane 710 is coincident with the plane of the DMD 550.

In addition, when a taper-type light tunnel is used, the incident angle on the reflective plane increases, and the reflective angle also increases. Therefore, the light emitted from the light tunnel 532 has a narrow angular distribution and improved degree of optical separation to thereby achieve a compact and slim illumination system. Therefore, the light tunnel according to one exemplary embodiment of the invention can irradiate light having an improved degree of optical separation and an improved image forming efficiency.

In the foregoing description, a DMD has been used to describe the light tunnel of the illumination system of the projection apparatus. The light tunnel may also be used with a projection apparatus that has an LCD (Liquid Crystal Display) or an LCOS (Liquid Crystal on Silicon).

As described above, according to the present invention, the projection apparatus having a light tunnel that uses features of both wedge and taper-types light tunnels can improve the degree of optical separation and image forming efficiency of the illumination light. The improved degree of optical separation improves the contrast ratio, while also provided a compact illumination system.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A light tunnel including an incident plane and an emitting plane of light for uniformly standardizing an intensity distribution of light emitted from a light source, wherein
the size of the emitting plane is larger than that of the incident plane, and
the emitting plane is inclined at an angle (θ) relative to the incident plane.

2. The light tunnel as claimed in claim 1, wherein
the light tunnel is formed by two rectangular and two trapezoidal mirrors, the incident and emitting planes are rectangular, and a light path from the incident plane to the emitting plane is a hollow space.

3. The light tunnel as claimed in claim 1, wherein
the light tunnel is formed from a hexahedral glass rod, the incident and emitting planes are rectangular, and a light path from the incident plane to the emitting plane is solid glass.

4. A projection apparatus comprising:
a light source including a lamp and a reflective mirror for providing a point light;
a light tunnel for converting the point light from the light source into a surface light, the light tunnel comprising an incident plane and an emitting plane for light, the size of the emitting plane being larger than that of the incident plane, and the emitting plane being inclined at an angle (θ) relative to the incident plane; and
an illumination system for reflecting and emitting the surface light by means of the reflective mirror.

5. The projection apparatus as claimed in claim 4, wherein
the light tunnel is formed by two rectangular and two trapezoidal mirrors, the incident and emitting planes are rectangular, and the light path from the incident plane to the emitting plane is a hollow space.

6. The projection apparatus as claimed in claim 4, wherein
the light tunnel is formed from a hexahedral glass rod, the incident and emitting planes are rectangular, and the light path from the incident plane to the emitting plane is a solid glass.

7. The projection apparatus as claimed in claim 4, wherein
the lamp is an arc lamp or a halogen lamp.

8. The projection apparatus as claimed in claim 4, wherein
the reflective mirror is an elliptical reflective mirror or a parabolic reflective mirror.

9. The projection apparatus as claimed in claim 4, further comprising:
a DMD (Digital Micro-mirror Device) including a plurality of micro-mirrors rotatably installed on a substrate for converting the light emitted from the illumination system into an optical image; and
a projection system for enlarging and projecting the optical image formed by the DMD.

10. The projection apparatus as claimed in claim 9, further comprising
a screen onto which the optical image, enlarged by the illumination system, is projected.

11. The projection apparatus as claimed in claim 4, further comprising
an LCD (Liquid Crystal Display) or an LCOS (Liquid Crystal on Silicon) for transmitting and converting the light emitted from the illumination system into an optical image.

12. The projection apparatus as claimed in claim 11, further comprising
a projection system for enlarging and projecting the optical image formed by the LCD or the LCOS.

13. The projection apparatus as claimed in claim 12, further comprising
a screen onto which the optical image, enlarged by the projection system, is projected.
